(19) United States
(12) Patent Application Publication
(10) Pub. No.: US 2005/0214731 A1
(43) Pub. Date: Sep. 29, 2005

(54) Evidence-based virtual instruction and evaluation system

(76) Inventor: Don B. Smith, Denver, CO (US)

Correspondence Address: LEE G. MEYER, ESQ.;MEYER & ASSOCIATES, LLC, 17462 E. POWERS DRIVE, CENTENNIAL, CO, 80015-3046, US

(21) Appl. No.: 10/809,726

(22) Filed: Mar. 25, 2004

(51) Int. Cl. G09B 7/00; G09B 3/00

(52) U.S. Cl. 434/322

(57) ABSTRACT

An evidence-based instruction and evaluation system, which presents users with scenarios containing a situational profile domain having parametric information defining a situation to be remedially addressed; and, a course of remedial action domain predicted upon evidence-based practice guidelines, which compares the users' selection to a set of predetermined responses, including those of experts in the field, to produce a graded tutorial for virtually instructing and/or evaluating the user. Advantageously, the scenario also includes an evaluation domain of empirically derived data relating to the profile domain presented. In a further aspect, the system is computerized and the domains reside on relational databases, such that one or more of the domain parameters can be independently changed to alter the response result.

### BACKGROUND OF THE INVENTION

1. Field of the Invention

The present invention relates generally to evidence-based instructional and evaluation systems; and, more particularly, to such systems which compare the user's responses to suggested problem solving strategies to a set of predetermined evidence-based responses, including those of experts in the field, to produce a graded tutorial for virtually instructing and or evaluating the user.

2. Description of Related Art

The last half of the 20^{th} century has seen an explosion of information from journal articles, to scientific research, to medical research, to promulgated legislation, to reported court cases. With the advent of computers and the Internet, as well as electronic storage and transmission, this information generation and dissemination has become mind-boggling. Professional practitioners, such as engineers, lawyers, and physicians, are faced with an overwhelming volume of data, which relates to their profession and impacts their continued ability to manage professional scenarios. Thus, these professionals, whose job it is to keep up with the latest techniques and information for problems solving, find themselves in an information quandary.

One defense to this information explosion is specialization. By specializing, the professional is able to become more familiar with a specific aspect of the profession and remain “up-to-date” with the latest tools, information, and suggested protocol without being overwhelmed. Thus, lawyers, engineers, and physicians have ever narrowing fields of practice. Cardiologists, securities and tax attorneys, or astrophysical engineers continually narrow their field of knowledge in order to maintain competency in the face of a burgeoning amount of literature.

The generalist is disappearing from the landscape, yet the necessity for the general practitioner is growing. Because the specialists practice in ever narrowing fields, there is a requirement that some practitioners initially recognize and/or diagnose the problem so that the correct specialist can be employed. Further, even within the specialty itself, there is a mountain of literature, studies, and procedures that tax the specialists' time constraints.

The legal system has for many years employed a fact or “evidence-based” method of teaching, called the Socratic Method. In this method, a factual pattern is described, and the student attempts to apply the appropriate statutes and case law to determine the legal outcome. This is the same method practicing lawyers use in evaluating a client's case. Because of the number of new cases, rules and statues, lawyers rely on practice guidelines and digests to keep up with the changes in the law. One advantage the lawyer has is starie decisis. This allows the lawyer to make evidence-based decisions, with some impunity, predicated upon a prior ruling based upon a similar fact pattern before the same court. Other professionals do not have this advantage, and are faced with more random outcomes based upon the states of nature. This is where statistical outcomes based upon regulated trials can be helpful.

Graduate business colleges have adopted the evidence-based method as well. Here students learn through factual case studies. Likewise, the medical profession has adopted this method of teaching students, whether by hypothetical patient symptoms, or in teaching hospitals, through residency using live subjects. Especially in the medical profession, the complexity and interrelationships of various diseases and the indicators, which may be associated with various management protocols, tax the ability of most medical practitioners to ingest and assimilate this information and data. To aid medical practitioners in disease diagnosis, systems have been and are being developed to collate medical diagnostic data for the more effective management of diseases and conditions by guiding physicians in prescribing treatments. Such prior art medical diagnostic systems, however, do not adequately provide an analytical framework for analyzing the individual patient's symptoms into meaningful diagnostic results, by collating such results into a disease indicator pattern. Furthermore, such systems do not address therapeutic and/or contraindicated treatment strategies.

Professional recommendations, decisions, and actions are guided by multiple sources. Therefore, medical education has emphasized the use of evidence-based reasoning in the clinical management of patients. Likewise, medical decisions and medical actions are guided by multiple information sources. These include personal experience, physiological reasoning, expert opinion, societal norms and regulations, and experimental evidence. All of these can be useful, but an important premise of evidence-based medicine is that the latter source is the most consistently reliable guide, particularly when the evidence is derived from mathematically-designed, randomized, controlled trials. A major recent thrust of medical education has been to encourage physicians to use evidence-based reasoning in the clinical management of their patients.

However, with more than 25,000 medical journals publishing more than 4 million articles a year, staying abreast of the “best evidence” is a daunting task for practitioners. To aid in this task and to encourage the adoption of sound evidence-based practices, the tactic of distilling evidence into succinct “Practice Guidelines” has become common place. Even so, evidence-based “practice guidelines,” alone, are insufficient in implementing evidence-based practices. Despite the best efforts of professional organizations, the slowness to adopt evidence-based “practice guidelines” may be due to a continuing lack of evidence awareness by physicians. In fact, one finds disconcertingly low rates of compliance with widely disseminated evidence-based treatment guidelines by very knowledgeable practitioners.

Awareness may not be the only explanation for the modest implementation rate of evidence-based “practice guidelines.” There appears to be a distinction between knowing what one should do and actually doing it. The gap between knowing and doing can be alarmingly large. A study of the National Cholesterol Education Program guidelines showed that 95% of physicians were aware of the guidelines, but in only 18% of their patients were the guidelines effectively implemented.

Teaching guidelines, laws or rules alone, therefore, have shown to have limited impact in effecting implementation. Such teaching methods lack the Socratic approach of teaching by use of example. Thus, practice guidelines that are general, not specific, typically fail to incorporate these strategies. Specifically, practice of treatment guidelines usually lack concrete examples to aid in clarification of the proper application. Further, many ignore very important clinical variables—leading the practitioner to be uncertain about specific application, i.e. whether they “fit” a particular clinical situation at hand. Moreover, many such guidelines fail to indicate the relative strengths and weaknesses of specific evidence, leading the practitioner to mix strong recommendations with weak ones. In doing so, the practitioner risks confusing recommendations of differing weights.

The use of factually based scenarios and evidence-based problems solving, although of great value in the medical profession, is not limited to that profession and finds wide application in many professions where application of evidence-based protocol is used to diagnose or solve the problem. It would, therefore, be advantageous to have a virtual tool, which includes many of the above learning strategies, in a simple interactive format that requires the interacting user to “elect” specific decisions in an effort to resolve relevant scenarios. It would be further advantageous to have a system wherein the interaction with the scenarios is predicated upon recommendations in published or otherwise available “practice guidelines” such that, as decisions are made, feedback becomes available to the user immediately.

It would be further advantageous to have such a system which is computer based such that it comprises an automated tutorial allowing evidence-based “correct answers” and which is statistically predicated upon the strength of the evidence within the database. Further more, it would be advantageous to have independent problem resolutions and opinions from recognized “experts” in the field so that a correlation between the answer and the expected outcome can be rendered. Finally, it would be advantageous to have a system that could be continually updated as new information and/or practice guides become available.

### SUMMARY OF THE INVENTION

It has now been discovered that an interactive, evidence-based virtual instruction and evaluation system, in which users learn by example, provides a system and method for evaluating and/or improving professional decision-making skills. The system provides a method of instruction, grounded upon user decisions, which evaluates a user's agreement with evidence-based recommendations. The method of instruction is supported by coaching in the form of text and graphic feedback that serves to reinforce or “correct” decisions, made by the user, by reference to evidence-based responses. The factual “presenting” scenarios are displayed in an efficient, iterative manner that allows many scenarios to be completed in a relatively short time period. In particular, the system can be used for instructing the art of decision making grounded upon evidence-based recommendations, as well as for evaluating an individual agreement with evidence-based recommendations.

An evidence-based teaching and evaluation system for improving informed, professional decision-making skills is provided. In accordance with the system, a virtual factually based, problem scenario is presented for user evaluation. The user responds to resolution queries for the scenario presented by the system. A ranking is tallied based upon the number of similar user responses and displayed against a set of responses by known experts in the field. In one aspect, the scenario consists of a single fact presentation. In another aspect, the scenario further comprises a further evaluation of the problem, advantageously, through scientific testing such as an MRI.

In a broad aspect of the invention, an interactive teaching/diagnostic tool allows a user to select a presenting profile domain; select a course of remedial action domain in response to the problem; and, then compare the user's selected course of remedial action with other users, as well as that of known standards in the field. Advantageously, an evaluation domain containing fact-based, empirically derived data for further defining the situation in the presenting profile is presented to the user to aid in selection of the remedial action. In accordance with the invention, the problem profile can be virtual or actual. In addition, a cross-referencing index is provided to allow the user to select opinions of experts in the field to determine the likelihood of success of a particular course of remedial actions as compared to those chosen by the experts.

In one aspect, a computer based system for improving and evaluating professional decision-making skills provides an automated, interactive, virtual clinic in which students learn by example. A student's decisions are stored and compared for agreement with evidence-based recommendations and/or with the consensus of a panel of experts. A kappa statistic is computed to correct for chance agreement. This statistic allows the teacher or researcher to compare the decision-making of individuals or groups in a quantitative manner.

In a medical setting, a teaching/diagnostic tool is provided, wherein a student or practitioner user can select a virtual or actual symptomatic patient profile and then prescribe a course of treatment for the virtual (or actual) patient and compare his diagnoses with that of known standard treatment in the field. In one aspect, these standards constitute known practice guidelines. In another aspect, these standards constitute opinions of experts in the field. In accordance with one aspect of the invention, the standard courses of action available for a specific set of conditions are rated such that the user can see the standard courses of action weighted as to their preference by practitioners in the field.

In accordance with an advantageous embodiment, the instant invention comprises a PC loaded program with direct user interface including a first course of action as a function of the presented conditions; and, the second, based upon expert opinions regarding the efficacy of the standard courses of action to a particular presented situation. The treatment scenarios are weighted such that the user can determine the preferred treatment regimen against a set of symptoms.

In another embodiment, the database is continually updated on a centralized server, which is networked through, for example, the Internet from individual kiosks or workstations. One area that is particularly adapted to this teaching/diagnostic method is patients' suffering from symptoms of stroke. In this scenario, the system of the instant invention interfaces with the student/practitioner via a fuzzy logic look-up scheme, which is predicated primarily on very specialized medical terms, specific to that area of medicine.

### BRIEF DESCRIPTION OF THE DRAWINGS

The following drawings form part of the present specification and are included to further demonstrate certain embodiments. These embodiments may be better understood by reference to one or more of these drawings in combination with the detailed description of specific embodiments presented herein.

FIG. 1 is a screenshot of a display in accordance with the invention detailing table links;

FIG. 2 is a screenshot of a comparative display in accordance with the invention detailing comparison links;

FIG. 3 is a screenshot of a display of the calculated kappa scores in accordance with the invention;

FIG. 4 shows the calculation of kappa scores in accordance with the invention;

FIG. 5 is a screenshot of a typical scenario display in accordance with the invention;

FIG. 6 is a screenshot of a typical domain display presented for response in accordance with the invention;

FIG. 7 is a screenshot of a typical domain display after response in accordance with the invention;

FIG. 8 is a screenshot of an evidence-based answer display in accordance with the invention;

FIG. 9 is a screenshot of a display reviling practice guidelines in accordance with the invention by showing the Practice advisory;

FIG. 10 is a screenshot of a display in accordance with the invention showing the expert opinion correlation;

FIG. 11 is a screenshot of a display in accordance with the invention showing the reset characteristics;

FIG. 12 is a screenshot of a display in accordance with the invention showing the compare feature;

FIG. 13 is a screenshot of a display showing interactive scenario domains in accordance with the invention;

FIG. 14 is a screenshot of a display showing another aspect of interactive scenario domains in accordance with the invention;

FIG. 15 is a screenshot of a display revealing the scrolled tool bar in accordance with one aspect of the invention.

### DISCUSSION OF THE SYSTEM NOMENCLATURE

As used herein, the following terms will have the meanings hereinafter set forth. A “practice guideline” means an evidence-based guideline or “practice advisory” published by researchers and experts in a professional field setting forth recommended remedies, procedures and treatments for various presenting problems. “Problem profile” means a domain in the presented scenario containing parametric information to provide “metes and bounds” to the problem presented. “Evaluation data” means a domain in the presented scenario containing empirical data or information, usually provided by scientific means or empirically based data gathering methods, such as an MRI, telemetry data, a material stress test, a blood test, a DNA test, or the like. “Remedial action” means a domain in the presented scenario, statistically predicated upon the strength of the evidence derived from mathematically-designed, randomized, controlled trials or definitive empirical data, such as a splint or cast to resolve a bone fracture shown by an X-ray.

### DETAILED DESCRIPTION OF THE INVENTION

Learning strategies that promote attention, arousals, and motivation, are more likely to be effective in promoting learned behavior than those that do not, particularly when they are combined with the use of feedback and reinforcement to convey an unambiguous message. Practice guidelines typically fail to incorporate these strategies. Professional practice guidelines, especially in medicine, employ generic bases for treatment, i.e. they do not present examples. Likewise, instructional and evaluation techniques, which employ guidelines for diagnosis, often fail because they are general in that they lack specific fact-based examples and ignore many of the pertinent clinical variables. Because of this, they do not engage the user in a problem solving, fact-based, exercise that leads to a specific conclusion based upon application of practice principles.

Statistically Based, Evaluation Guidelines for Decision Making

The inventive method and system were created in an effort to address the shortcomings of practice guidelines. The method and system of the instant invention provide an analytical framework for analyzing the individual patient's symptoms into meaningful diagnostic results, by collating such results into a disease indicator pattern and presenting a therapeutic and/or contraindicated treatment strategy.

Advantageously, a computer-based tool that includes the above learning strategies provides an interactive format that requires the user to commit to dichotomous management decisions in specific, factually based or clinically relevant scenarios. The scenarios themselves can be built upon the general recommendations of the published practice guidelines. Once a decision is made, immediate text and graphic feedback becomes available, as does, for example, access to the practice guideline from which the scenario was constructed. The feedback includes the evidence-based “correct answer” and a comment on the strength of the evidence. Independent opinions from a panel of experts are also available.

In accordance with the instant invention, there is provided a step-wise scenario that takes the user through a series of steps that engages the user in a Socratic or problem solving exercise by first presenting a factually-based problematic situation, whether hypothetical or real, then in one embodiment providing a set of factually-based data relating to the initial evaluation of the presentation such as lab analysis, x-rays, MRI, or the like; and, finally, requiring or presenting a subsequent course of action to resolve, solve, or treat the scenario originally presented. The user is then “scored” upon the choice of action presented against evidence based data and/or expert responses in the field.

In accordance with one aspect of the invention, a course is presented, and the user merely accepts or rejects the proposed course. In another aspect, various courses are presented, one or more of which may have redeeming attributes, and the user is requested to select the “best” answer or treatment. A user's decisions are stored and compared for agreement with evidence-based recommendations and/or with the consensus of a panel of experts. A kappa statistic is computed to correct for chance agreement. This statistic allows the teacher, or researcher, to compare the decision-making of individuals or groups in a quantitative manner.

In another aspect, the evidence-based system allows educators, including teaching physicians, to evaluate or measure the proficiency of the user in different scenarios. In one aspect, a simple numerical rating or kappa score is able to be assessed. In another aspect, rankings among groups can be determined, as well as changes of the same group over time allowing the educator to assess the effectiveness of the teaching techniques.

In another aspect, the user may explore the scenarios in an ad-hoc manner for situations of personal interest. An efficient, iterative method of presenting the scenarios allows many scenarios to be worked through quickly. Once a set of scenarios has been completed, the user's answers are stored, and a detailed user “report card” is generated. This compares the user's decisions against the evidence-based recommendations and against the verdicts of the expert panel. For these comparisons as well, the system calculates a kappa score to correct for chance agreement.

In accordance with the automated system, an individual PC can be used as the “training kiosk” with the software being loaded on the PC by, for example, use of a CD ROM, such that the evidence-based virtual clinic teaching system is substantially self-contained. In another aspect, individual stations can be networked by, for example, the Internet, so that a central location can be used to interact with a number of work stations or kiosks. In this manner, it can be readily seen that interactive scenarios can be presented, and the system easily updated with current “best” practices information. Another advantage of the networked system is the real time interaction of a single educator and a number of users, so that evidence-based responses could be, for example, discussed among users or among users and educators. For instructors, the system provides a simple numerical score indicating the student's level of concurrence with evidence-based recommendations. For researchers, the score can be used to assess differences among groups and changes over time.

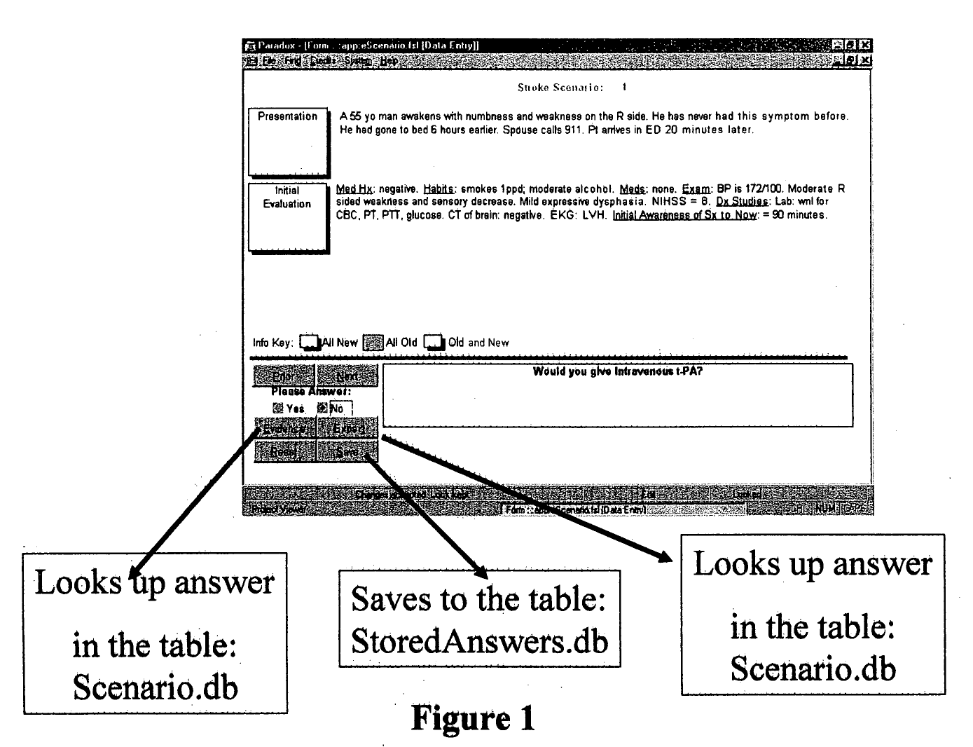

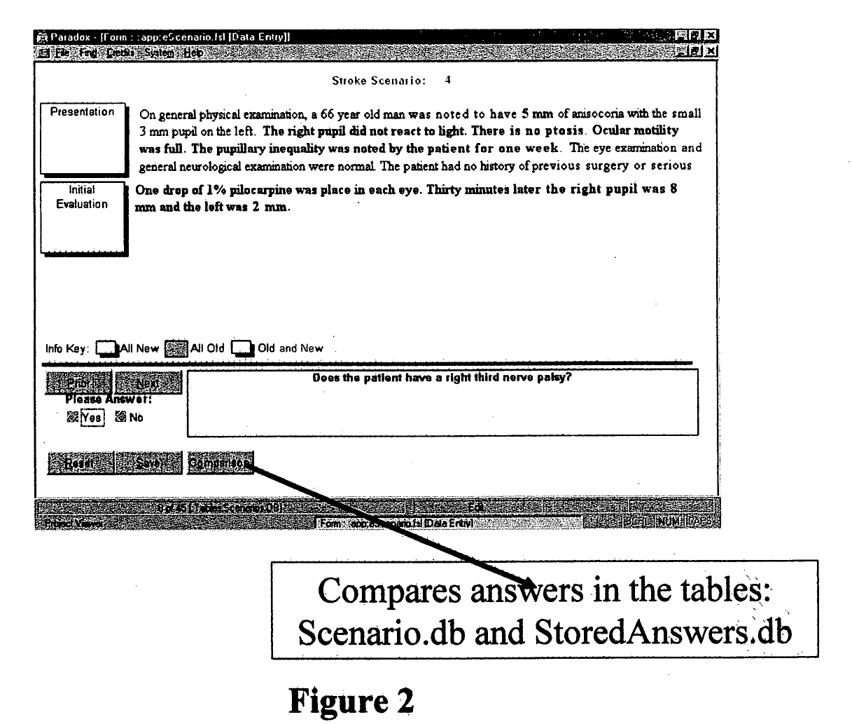

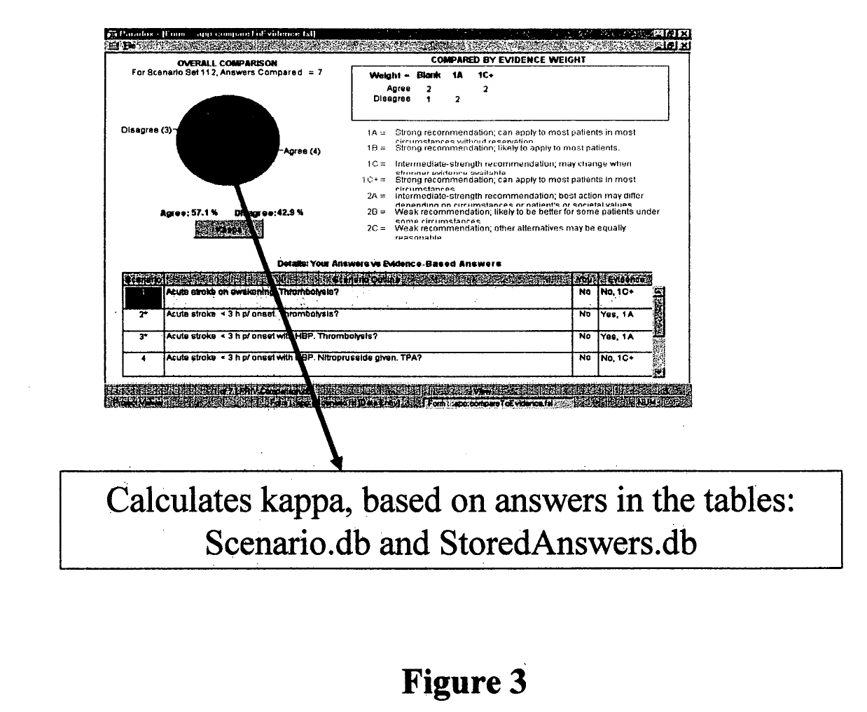

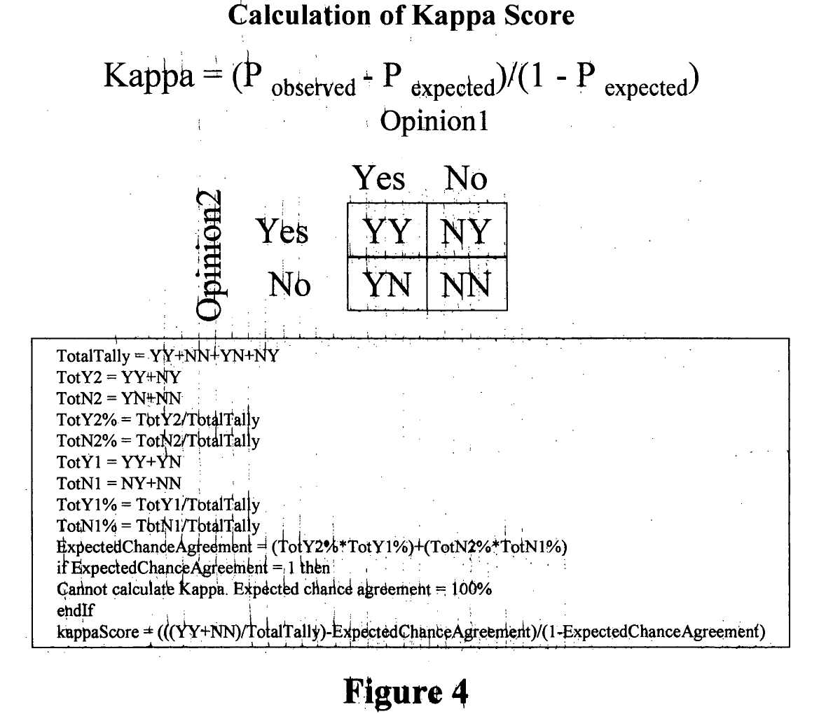

Turning now to the Figures, there is shown a series of “screen shots” which exemplify the features of the system. FIG. 1 represents a table, detailing links, once the question has been answered, allowing the user to save the results. FIG. 2 is a screenshot of a comparative display in accordance with the invention detailing comparison links showing the comparison of the user's stored answers and the system evidence-based answers. FIG. 3 shows the calculation of the kappa score “grade” for the user using the methodology in FIG. 4.

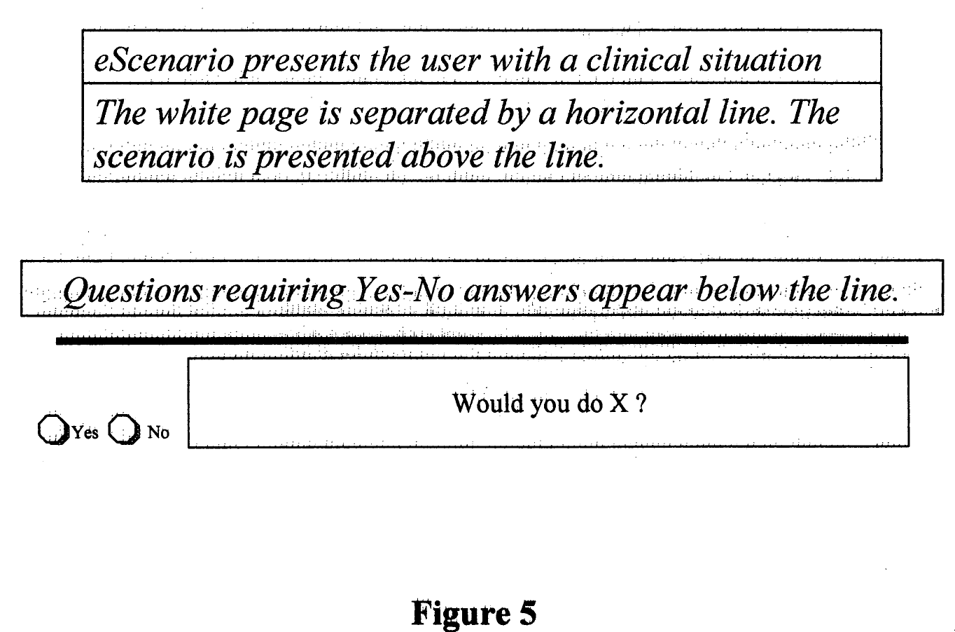

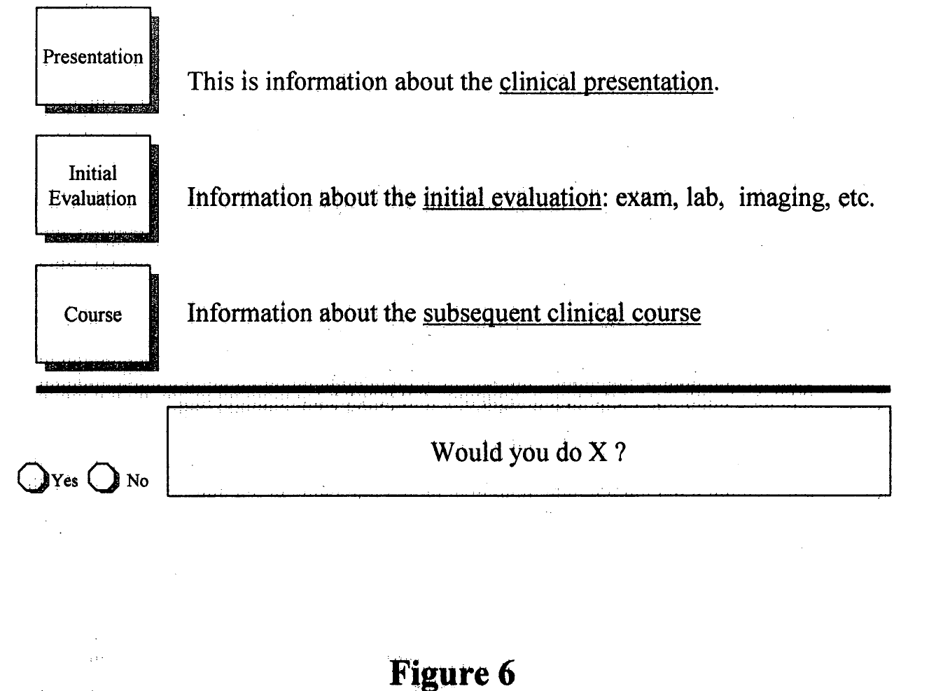

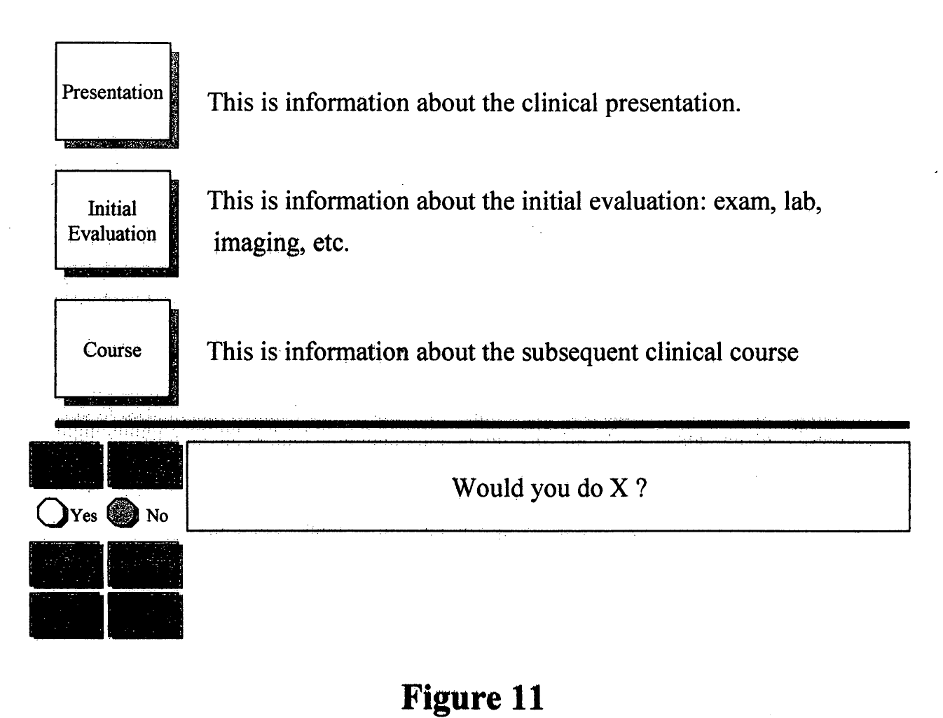

Turning to FIGS. 5 through 15, there is shown a procedural, step-by-step advance through an exemplary computerized version of one embodiment of the inventive system and method relating to the medical profession. FIG. 5 exemplifies the presentation to the user with a situational profile presentation domain and an evaluation domain in a clinical situation and then asks for a decision about a management issue. Questions requiring “Yes-No” answers appear below the line, as better shown in FIG. 6. As shown in FIG. 6, the scenario space is divided into 3 domains, as further explained below. The first is the situational profile presentation. The second is the derived information from testing or the evaluation domain; and, the third a suggested course of remedial action. In the represented embodiment, the user is asked to agree or disagree with the course of remedial action by recording a response on the buttons “Yes-No.”

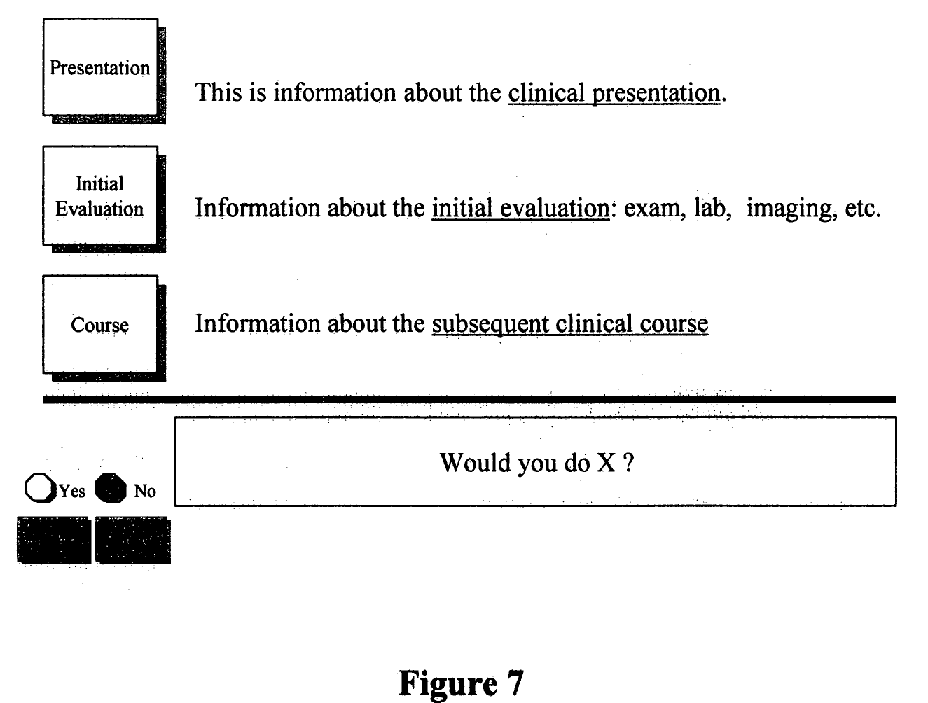

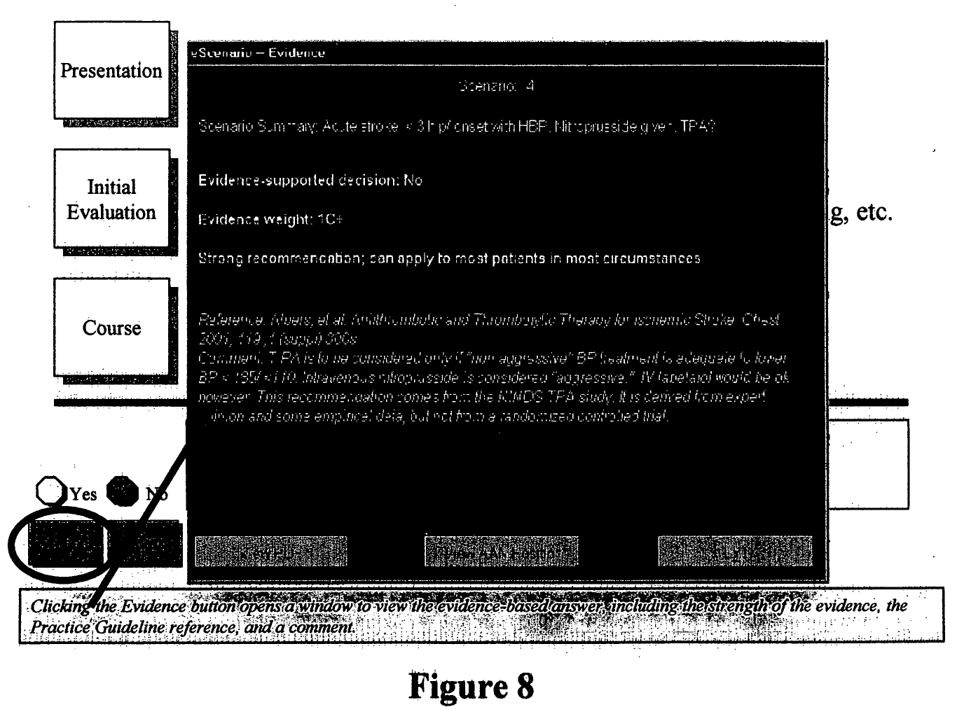

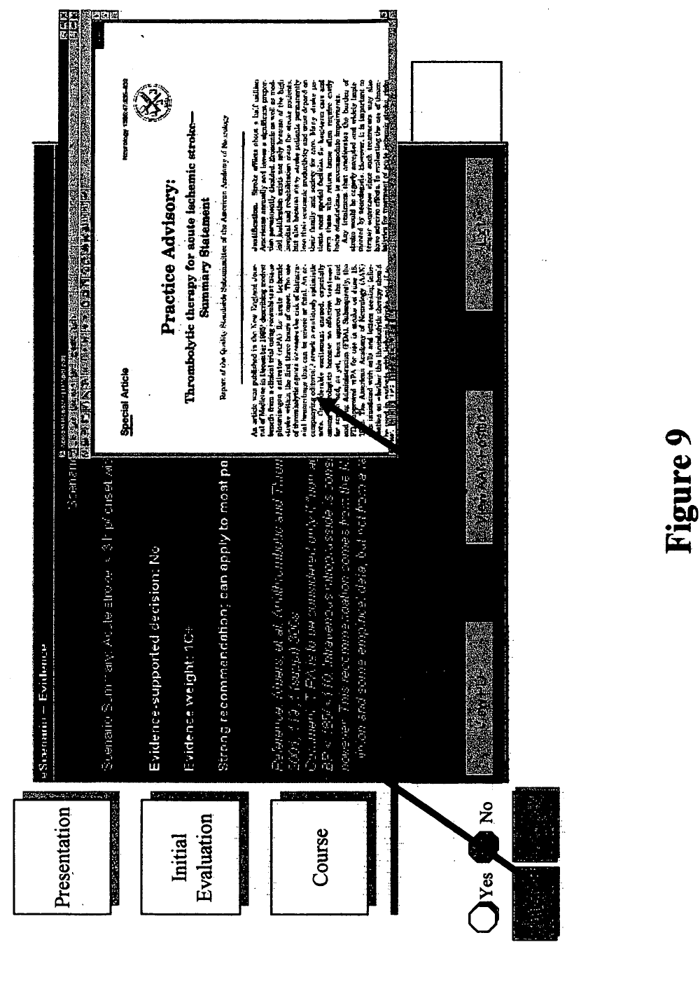

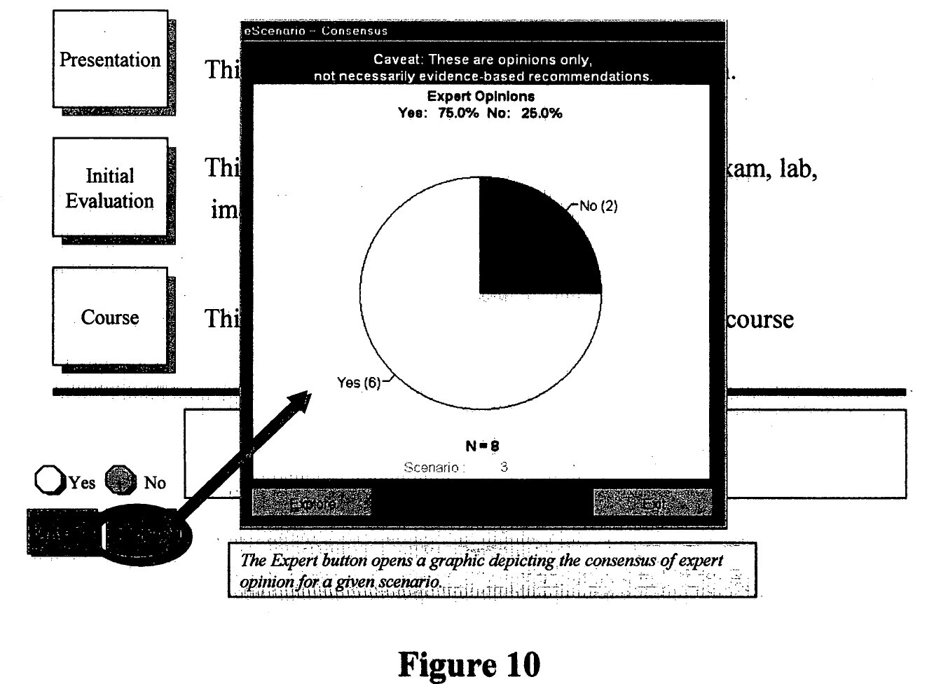

As shown in FIG. 7, once a question is answered, the user has access to an evidence-based answer from the practice guidelines, as well as access to a consensus of expert opinion. As shown in FIG. 8, clicking the “EVIDENCE” button opens a window to view the evidence-based answer, including the strength of the evidence, the Practice Guideline reference, and a comment. The access to the referenced Practice Guideline (Advisory) as a PDF document is obtained by pressing the indicated button, as better shown in FIG. 9. Turning to FIG. 10, depressing the “EXPERT BUTTON” opens a graphic depicting the consensus of expert opinion for a given scenario. Clicking the “EXPLORE” button, in the “consensus” window, shows the opinions of other users who have worked through the scenarios and saved their responses. This then accesses a cumulative response database which is anonymous or can be grouped by, for example, area of expertise or discipline.

Once a particular scenario is worked through, the answer can be “saved,” or the system “reset” for the next user. The “PRIOR/NEXT” buttons allow the user to navigate through the scenario domain databases depending upon the tutorial in play. The “SAVE” button stores the user's answers to the hard drive, after asking for identifying information that will allow for later analysis of how people in various groups compare with one another, and with the evidence/experts. Additionally, the date is stored, so that trends over time can be analyzed. The “RESET” button clears all of the answers entered, without saving them, and resets the program for the next user.

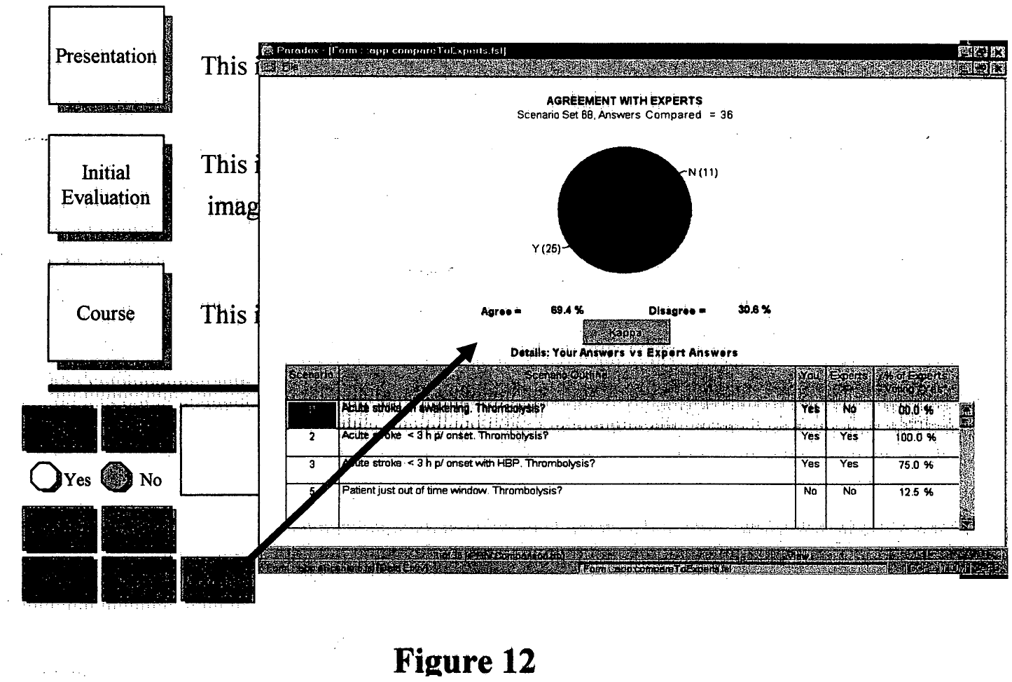

FIG. 12 shows the user a thumbnail sketch of the each scenario and how the user compares to the consensus of expert opinion on each scenario responded to. When a user's answers are saved, the “COMPARE” button appears. This allows a user to compare the user's answers overall with the evidence-based and/or expert-consensus answers as shown. The “COMPARE” button also calculates the kappa statistic to correct for chance agreement.

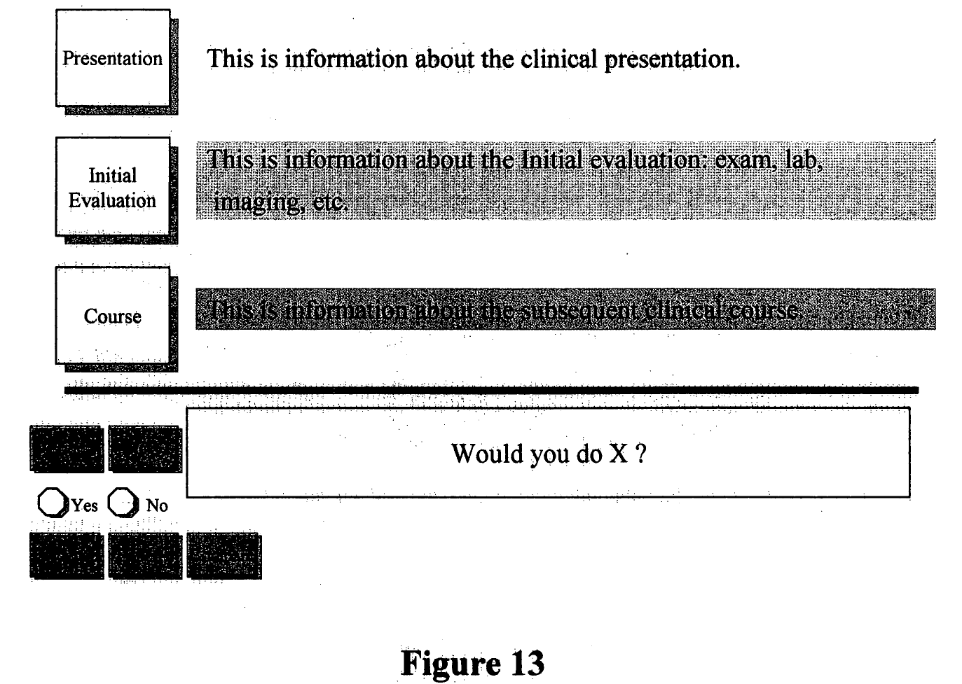

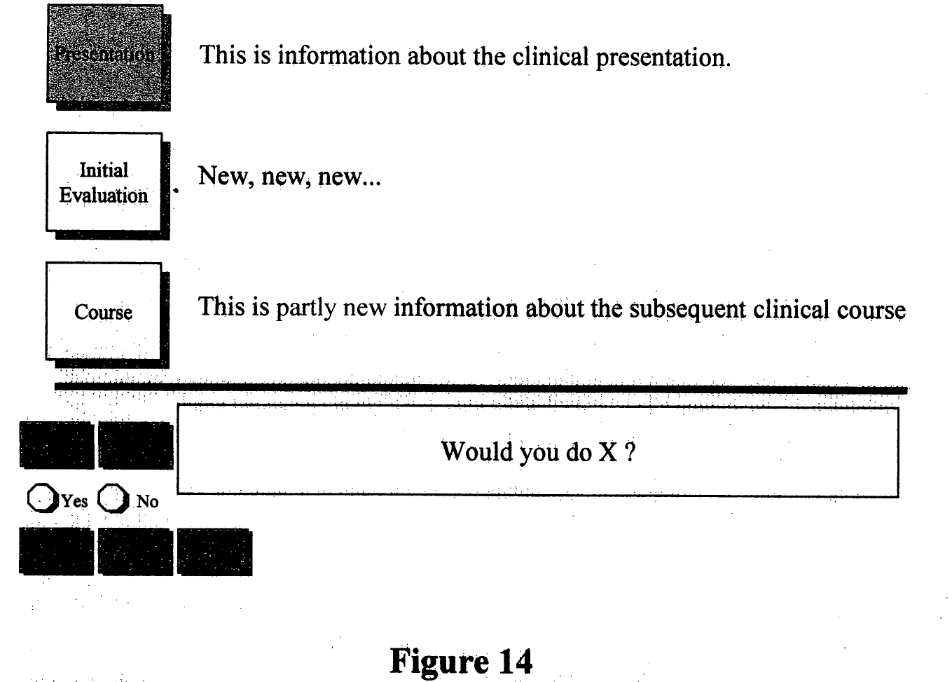

In accordance with the invention, the presentation is efficient and iterative to allow the user to work through multiple scenarios quickly. For example, as shown in FIG. 13, the three domains are color-coded for quick identification. As shown in FIG. 14, relational databases showing, for example, the same presentation, but a different evaluation domain, is handled by color-coding the text and the domain box. For example, if the domain box is gray, all of the information in that domain is exactly the same as in the preceding scenario, and it does not need to be re-read. When the domain box is white and all of the text is black, all of the information in that domain is new, and it should be read completely. When the domain box is white, and some of the text is red, then only the red information is new. The black text is exactly the same as in the preceding scenario. It will be realized by the skilled artisan that many formats to facilitate user interface are possible, and the above are only exemplary.

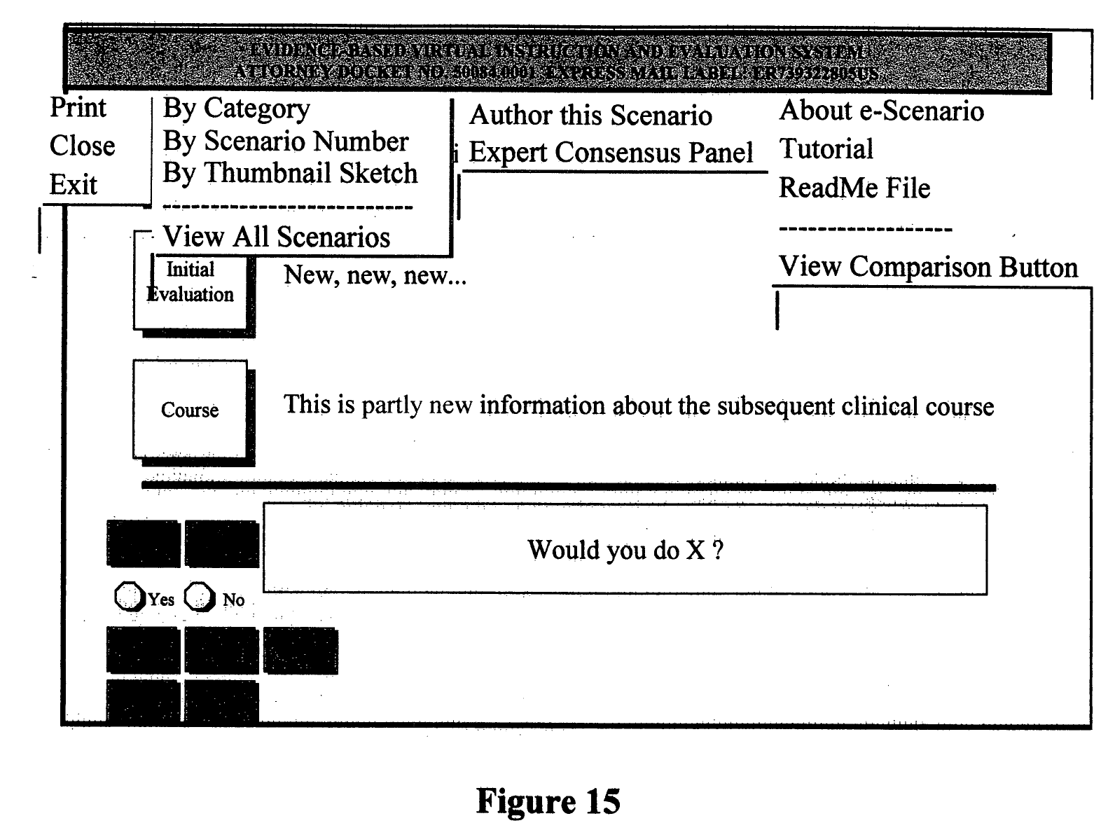

Finally, as enlarged in FIG. 15, the system contains a menu bar at the top of each screen to provide additional functions. “FILE” allows user to 1) print all scenarios, 2) close the window, and 3) exit the program. “FIND” offers searching for and filtering scenarios: by category; by number; and, by words in the thumbnail sketch. “VIEW-ALL-SCENARIOS” restores all scenarios to the program. “CREDITS” allows user to know the author of a particular scenario and the expert panelists who voted on the scenarios. However, an individual expert's opinion is not displayed. “SYSTEM” offers information about the user's computer, which may be needed for troubleshooting. “HELP” gives: 1) information about the version of the system, 2) access to tutorial to learn how to use the system, 3) access to a “ReadMe” file with additional information on the systems, 4) an opportunity to review overall comparison of your answers with the evidence/expert answers.

Situational Profile Presentation Domain

In accordance with the inventive method, each scenario contains a presenting profile domain. This scenario domain contains parametric information “defining” the situation to be remedially addressed. It provides the user with the “metes and bounds” of the conditions, symptoms or the like to be addressed in the remedial action. This profile is a factually reported or displayed, usually verbal, scenario domain upon which the problem is predicated and presented to the user. Examples of such presentations include symptoms of a patient, facts related to a situation such as a disaster in a spacecraft, an earth quake, telecommunications disruption, and the like.

The situational profile presentation domain database is populated by a number of presentations that are, for example, derived from scenarios relating to situations described in practice guidelines upon which the remedial actions, discussed below, are predicated. Conditions, such as rapid heart rate, numbness, light-headedness, fainting, chest pains, stomach pains, join pains are examples of symptoms used in presentations involving a medical scenario. The situational profile presentation domain database is advantageously initially populated in the system and can comprise, for example, sets of databases having concurrent symptoms or fact patterns relating to related conditions. In accordance with one aspect, the situational profile presentation domain database contains overlays, as will be hereafter described, such that a series of scenarios presented can be slightly altered in manner so that the user can understand the relationship between varied conditions or symptoms and the ultimate prognosis or remedial course. This overlay aspect is especially useful in tutorials relating to the legal profession, wherein slight changes in fact patterns change the outcome.

Evaluation Domain

The evaluation domain is predicated upon input of fact-based, empirically derived data, helpful in allowing the user to select a remedial action. This domain is not necessary for the practice of the instant invention, but is advantageous. In one aspect, the evaluation domain is initially blinded from the user, and then revealed to allow the user to determine if the user would change the remedial action based upon the evaluation domain information. The evaluation domain database is populated with data or information which is empirical, such as that provided by scientific means or empirically based data gathering methods. This data is relational to the situational profile presentation domain database presented in the tutorial and may be independently changed to present a new scenario to the user based upon the original situational profile presentation.

The evaluation domain, thus, adds additional empirical information to the scenario which information is usually based upon gathered factual data based upon testing or the like including those tests performed with the aid of scientific instruments. Thus, scientific evidence, such as blood sugar, X-Ray, MRI, EKG, field strength tests, temperature, and the like, is used to provide empirical data relative to the situational profile presentation domain. Evaluation domain data could also, for example, be testimony of a witness, expert witness, altimeter drop rate in an airplane, cryogenic temperature measurement in a fuel cell, or increase in impedance in an electrical circuit.

As with the situational profile presentation scenario domain, discussed above, the evaluation domain database can be populated to present variations in evaluation data for a given situational profile presentation domain. Thus, for example, leg pain, presented, from trauma would be diagnosed differently, if X-Ray evidence of a fracture were present. Thus, the initial domain evaluation database overlay can change to suggest an altered remedial course of action. The situational profile presentation domain database and the initial evaluation domain database form a relational link, one with another, such that certain presentations require or dictate specific initial evaluation domain data which gives information related to the course of remedial action.

In accordance with one aspect, the evaluation domain data is a presentation of unrelated or counter indicated information. In accordance with this aspect, the user is required to asses the relevance of the evaluation domain data to the fact presented in the situational profile presentation domain. In this manner, unrelated or superfluous evaluation domain data is used as a training tool to help the user discern relevant evaluation information.

Course of Remedial Action

The course of remedial action is also a domain of the scenario and presents the user with a resolution or course of action predicated upon the scenario previously presented. This can include the situational profile presentation domain and the evaluation domain, or only the situational profile presentation domain. The remedial action domain contains suggested remedial actions to rectify or address the situational profile presentation domain. This may include the information presented in the evaluation domain or not.

The remedial action domain presents courses of action to address or remedy the situational profile presentation domain predicated upon the practice guidelines. The most reliable basis for decision making comes from evidence-based trials, especially those which have a statistical basis. Such evidence-based resolution gives the practitioner a “more likely than not” scenario based upon a set of presenting criteria. Advantageously, the suggested responses are statistically predicated upon the strength of the evidence derived from mathematically-designed, randomized, controlled trials or definitive empirical data as set forth in the evidence-based advisory or guideline published by researchers and experts in a professional field setting forth recommended procedures and treatments.

As discussed above, as with the other two domains, various aspects of the remedial course can be altered to present different resolution or treatment scenarios for the same or substantially the same presented facts and evaluation. The user is then “graded” upon a response to “acceptance” or “rejection” of the remedial course; or, in the alternative, to choosing the “best” remedy from among a number of remedial action choices.

Thus, as can be seen from the foregoing discussion, the system and method of the instant invention present a cascade of relational information, which result in a problem based factual presentation with suggested remedies or diagnoses to identify or rectify the true nature of the problem and the outcome of the remedial action is compared to evidence-based trials and/or experts in the field.

Scoring

Once a particular course of action is embarked upon, the system is able to score the response and/or present to the user the course selected by experts in the field, including the statistical selection among experts. In this manner, the decisions can be ranked in accordance with their correlation to those supported by the evidence. Advantageously, a waiting factor can be assigned. In accordance with the automated system of the instant invention, a score card can be presented comparing details of a set of a user answers to, for example, a set of answers by experts.

Thus, the system of the instant invention presents to the user a virtual clinic allowing the honing of skills based upon evidence-based practices developed by encountering a myriad of virtual patients in substantial quantities and presenting varying degrees of conditions. Advantageously, the user can concentrate on addressing the presentations in low stress environment, and the structure of the evidence based virtual clinic avails itself for use by either groups or individuals.

For students, the system offers a “virtual clinic” in which evidence-based practices can be inculcated. Efficiency and ease of use allow the student to build evidence-based skills by encountering of a large number and variety of “virtual patients” in the low stress environment of his or her own PC. Through repeated variations on a theme, the system can reinforce evidence-based recommendations. In addition, the system can be used to highlight clinical uncertainties. Scenarios can be crafted to mirror the complex and controversial situations encountered in clinical practice. In these, the evidence may be silent, and the expert consensus may be evenly divided. The system can, thus, teach both evidence-based recommendations and the limitations of the evidence-based approach.

Updating the System

Since the half life of “truth” in medicine and other professions is finite, “best practice” is a continually moving target. The system can be updated to reflect the latest iteration of best Practice Guidelines. Internet access in a network can provide an additional tool for up-to-the-moment continuing medical education. It could also be used as a of “measure evidence-awareness” among members of professional organizations. It could measure the membership's consensus about difficult scenarios for which evidence is lacking. These measures could be tracked over time and across organization-specified variables.

Finally, the system can be used to compliment and amplify the educational effect of didactic lectures in grand rounds, conferences, and similar group settings. These features can be useful to both the teacher and the student of evidence-based medicine. For teachers, it provides a simple numerical score indicating the student's level of concurrence with evidence-based recommendations. For researchers, the score can be used to assess differences among groups and changes over time. Through repeated variations on a theme the system can reinforce evidence-based recommendations.

It can measure the consensus about difficult scenarios for which evidence is lacking. These measures could be tracked over time and across user-specified variables. In accordance with the automated aspect of the instant invention, overlays can be used to refine, redefine, or change the original presentation. By using a color-coded domain, the user is informed whether the presentation is exactly the same as the last scenario, or is completely new, or partially new. This coding can be used to reflect changes and additions to the presentation, initial evaluation, and/or course of treatment.

The foregoing discussions, and examples, describe only specific embodiments of the present invention. It should be understood that a number of changes might be made, without departing from its essence. In this regard, it is intended that such changes—to the extent that they achieve substantially the same result, in substantially the same way—would still fall within the scope and spirit of the present invention.

1. A system for evidence-based, virtual instruction and/or evaluation of a user comprising:
a). a presenting profile domain containing parametric information regarding a situation to be remedially addressed;
b). a remedial action domain containing at least two courses of action, predicated upon practice guidelines, for remedially addressing the situation in the presenting profile;
c.) means for selecting at least one of said courses of action; and,
d.) means for comparing at least one course of action to a group selected from courses of action selected by experts in the field of the presenting profile domain, and, an evidence-based set of selected courses of action, or a combination thereof.

2. The system of claim 1 further comprising, an evaluation domain containing fact-based, empirically derived data for further defining the situation in the presenting profile.

3. The system of claim 1 further comprising means for storing said selected at least one of said courses of action for remedially addressing the situation in said presenting profile.

4. The system of claim 1 further comprising means for resetting said system.

5. The system of claim 1 further comprising means for scoring and calculating a kappa score based upon said stored selected at least one of said courses of action for remedially addressing the situation in said presenting profile.

6. The system of claim 1 further comprising means for displaying the practice advisory guideline upon which the evidence-based set of selected courses of action is based.

7. The system of claim 1 wherein said presenting profile domain and said a remedial action domain are relational allowing partial relative change of one with respect the other.

8. The system of claim 2 wherein said presenting profile domain, said evaluation domain and said a remedial action domain are relational allowing partial relative change of one with respect the other.

9. The system of claim 1 wherein said system is computerized.

10. A method for evidence-based virtual instruction and evaluation of a user comprising the steps of:
a). populating a first database with a presenting profile domain containing parametric information regarding a situation to be remedially addressed;
b). populating a second database with a remedial action domain containing at least two courses of action, predicated upon practice guidelines, for remedially addressing the situation in the presenting profile;
c). selecting at least one of said at least two courses of action;
d.) comparing said selected at least one course of action to a group selected from courses of action selected by experts in the field of the presenting profile domain, and, an evidence-based set of selected courses of action, or a combination thereof

11. The method of claim 10 comprising the further step of populating a third database with an evaluation domain containing fact-based, empirically derived data for further defining the situation in the presenting profile.

12. The method of claim 10 comprising the further step of storing said selected at least one of said courses of action for remedially addressing the situation in said presenting profile.

13. The method of claim 10 comprising the further step of purging said selected at least one of said courses of action for remedially addressing the situation in said presenting profile.

14. The method of claim 10 comprising the further step of calculating a kappa score based upon the stored selected at least one of said courses of action for remedially addressing the situation in said presenting profile.

15. The method of claim 10 comprising the further step of displaying the practice advisory guideline upon which the evidence-based set of selected courses of action is based.

16. The method of claim 10 wherein said presenting profile domain database and said a remedial action domain database are relational allowing partial relative change of one with respect the other.

17. The method of claim 11 wherein said presenting profile domain database, said evaluation domain database and said a remedial action domain database are relational allowing partial relative change of one with respect the other.

18. A computerized system for evidence-based, virtual instruction and/or evaluation of a user having a means for data storage and a means for data processing, comprising:
a.) a first relational database in said means for data storage, said first database comprising a presenting profile domain containing parametric information regarding a situation to be remedially addressed;
b.) a second relational database in said means for data storage, said second database comprising a remedial action domain containing at least two courses of action, predicated upon practice guidelines, for remedially addressing the situation in the presenting profile;
c.) a third relational database in said means for data storage, said third database comprising an evidence-based set of selected courses of action for remedially addressing the situation in the presenting profile;
d.) a forth relational database in said means for data storage, said forth database comprising courses of action selected by experts in the field of the presenting profile domain; and,
e.) means for selecting at least one course of action from said second database;
f.) means for comparing said at least one course of action to said data in said third data base; or, said forth data base; or, both.

19. The computerized system of claim 18, further comprising a fifth relational database in said means for data storage, said fifth database comprising an evaluation domain containing fact-based, empirically derived data for further defining the situation in the presenting profile.

20. The computerized system of claim 18, wherein said system is networked.

21. The computerized system of claim 20, wherein said network comprises the internet

22. The computerized system of claim 19 further comprising means for updating said data bases.

23. The computerized system of claim 19 further comprising a sixth relational database in said means for data storage of said at least one of said courses of action for remedially addressing the situation in said presenting profile, said sixth database comprising said selected at least one of said courses of action for remedially addressing the situation in said presenting profile.

24. The computerized system of claim 18 having a device for resetting said system.

25. The computerized system of claim 18 further comprising data processing means for scoring and calculating a kappa score based upon said stored selected at least one of said courses of action for remedially addressing the situation in said presenting profile.

26. The computerized system of claim 18 further comprising data processing means for displaying the practice advisory guideline upon which the evidence-based set of selected courses of action is based.

27. The computerized system of claim 18 further comprising data processing means for partially changing said remedial action domain with respect to said profile domain containing parametric information regarding a situation to be remedially addressed;

28. The computerized system of claim 19 further comprising data processing means for partially changing said remedial action domain and said evaluation domain with respect to said profile domain containing parametric information regarding a situation to be remedially addressed.
